(19) United States
(12) Patent Application Publication
(10) Pub. No.: US 2013/0293828 A1
(43) Pub. Date: Nov. 7, 2013

(54) GLASSES FRAME

(71) Applicant: CHAO-NAN KUO, TAINAN CITY (TW)

(72) Inventor: CHAO-NAN KUO, TAINAN CITY (TW)

(21) Appl. No.: 13/464,142

(22) Filed: May 4, 2012

(51) Int. Cl. G02C 5/14

(52) U.S. Cl. 351/121

(57) ABSTRACT

A glasses frame comprises a body, two temples and two connecting members. The body has two ends pivotally connected to a second end of each of the connecting members. Each of the temples includes a first notch, a first pivot hole in communication with the first notch, a first engaging tooth formed on an inner surface of the first notch. The two connecting members each include a first protruding member at a first end thereof and to be inserted in the first notch and a plurality of annularly arranged first engaging grooves for engaging with the first engaging tooth. With the first engaging tooth selectively engaged in one of the first engaging grooves, the two temples can be adjusted in up and down directions to better fit different faces.

### BACKGROUND OF THE INVENTION

1. Field of the Invention

The present invention relates to a glasses frame, and more particularly to a glasses frame whose temples can be adjusted to better fit the user's face.

2. Description of the Prior Art

A pair of conventional glasses generally consists of two lenses disposed in a frame, and two temples pivoted to the frame by screws. When not in use, the temples can be folded. However, the wearing angle of the conventional glasses is not adjustable to fit different faces. Moreover, it has to use screws to fix the two temples to the frame, which makes the assembly of the glasses complicated, and the screws are tiny and very likely to be lost after the temples are disassembled.

The present invention has arisen to mitigate and/or obviate the afore-described disadvantages.

### SUMMARY OF THE INVENTION

The primary object of the present invention is to provide a glasses frame which comprises a body, two temples and two connecting members.

Each of the two temples includes a first notch, a first pivot hole in communication with the first notch, a first engaging tooth formed on an inner surface of the first notch.

The two connecting members each include a first protruding member at a first end thereof and to be inserted in the first notch. The first protruding member is provided with a first pivoting member to be pivotally inserted in the first pivot hole and a plurality of annularly arranged first engaging grooves for engaging with the first engaging tooth.

The body has two ends pivotally connected to a second end of the each of the connecting members, respectively.

With the first engaging tooth selectively engaged in one of the first engaging grooves, the two temples can be adjusted in up and down directions to better fit different faces.

### BRIEF DESCRIPTION OF THE DRAWINGS

FIG. 1 is a perspective view of a glasses frame in accordance with the present invention;

FIG. 2 is an exploded view of a part of the glasses frame in accordance with the present invention;

FIG. 3 is an exploded view of another part of the glasses frame in accordance with the present invention;

FIG. 4 is a cross sectional view of a part of the glasses frame in accordance with the present invention, showing the initial state when the first protruding member is inserted in the first notch, or the second protruding member is received in the second notch;

FIG. 5 is a cross sectional view of a part of the glasses frame in accordance with the present invention, showing that the first protruding member is inserted in the first notch, or the second protruding member is received in the second notch;

FIG. 6 is a cross sectional view of a part of the glasses frame in accordance with the present invention, showing that the second engaging tooth is engaged in one of the second engaging grooves;

FIG. 7 is a cross sectional view of a part of the glasses frame in accordance with the present invention, showing that the connecting member and the temple are adjusted in left and right directions;

FIG. 8 is a cross sectional view of a part of the glasses frame in accordance with the present invention, showing that the first engaging tooth is engaged in one of the first engaging grooves; and

FIG. 9 is a cross sectional view of a part of the glasses frame in accordance with the present invention, showing that the connecting member and the temple are adjusted in up and down directions.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

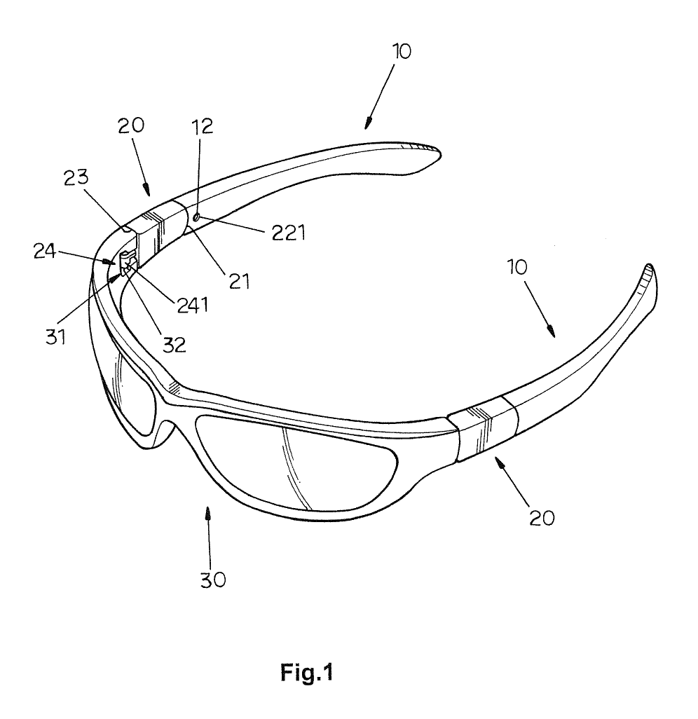

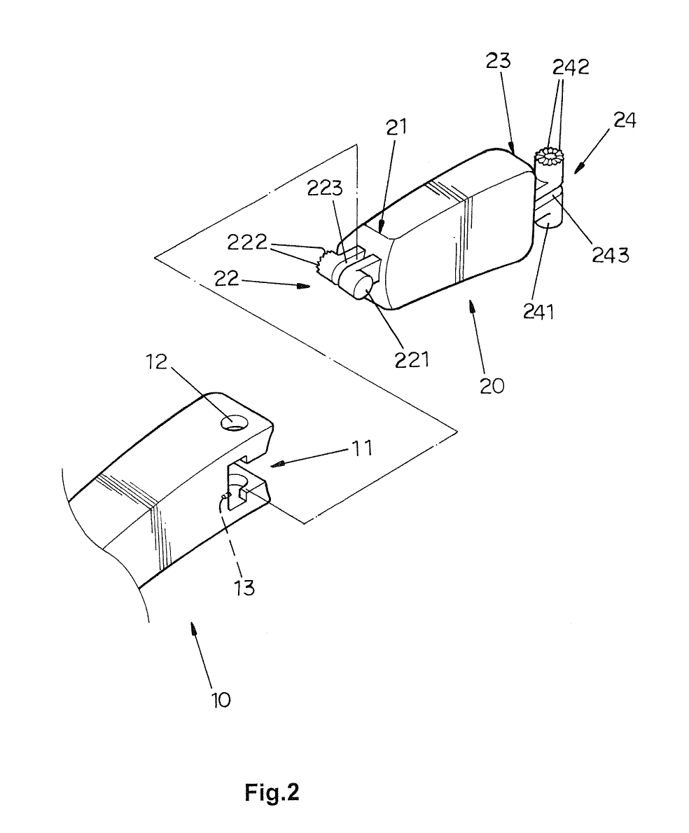

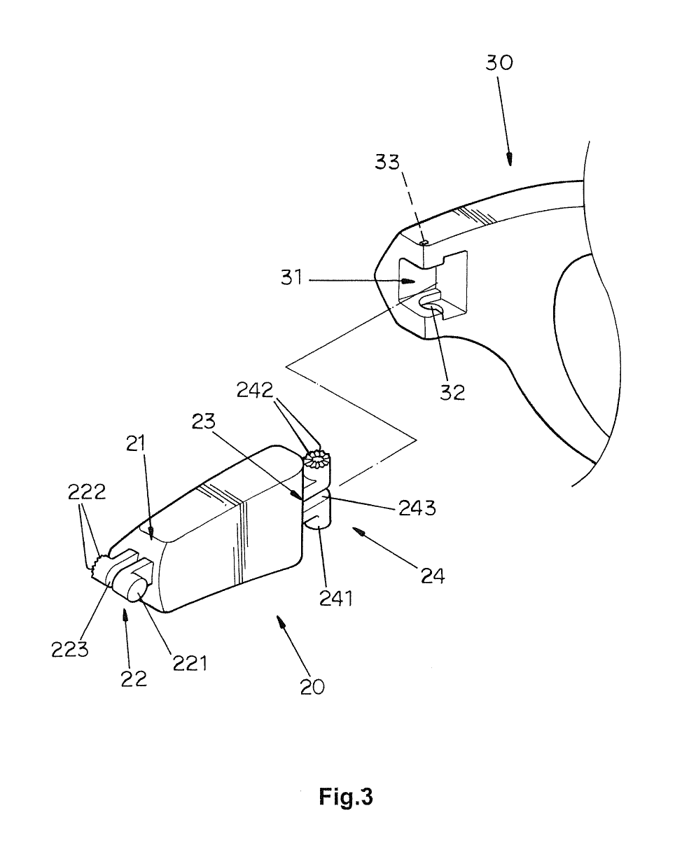

Referring to FIGS. 1-3, a glasses frame in accordance with the present invention comprises two temples 10, two connecting members 20 and a body 30.

Each of the temples 10 includes a first notch 11, a first pivot hole 12 in communication with the first notch 11, a first engaging tooth 13 formed on an inner surface of the first notch 11.

Each of the connecting members 20 includes a first protruding member 22 at a first end 21 and a second protruding member 24 at a second end 23. The first protruding member 22 is provided with a first pivoting member 221 to be pivotally inserted in the first pivot hole 12, a plurality of annularly arranged first engaging grooves 222 for engaging with the first engaging tooth 13, and an interval 223 between the first pivoting member 221 and the first engaging grooves 222. The second protruding member 24 is provided with a second pivoting member 241, a plurality of annularly arranged second engaging grooves 242, and an interval 243 between the second pivoting member 241 and the second engaging grooves 242.

The body 30 is provided at each of two ends thereof with a second notch 31, a second pivot hole 32 in communication with the second notch 31 for pivotally connecting the second pivoting member 241, and a second engaging tooth 33 formed on an inner surface of the second notch 31 to selectively engage with one of the second engaging grooves 242.

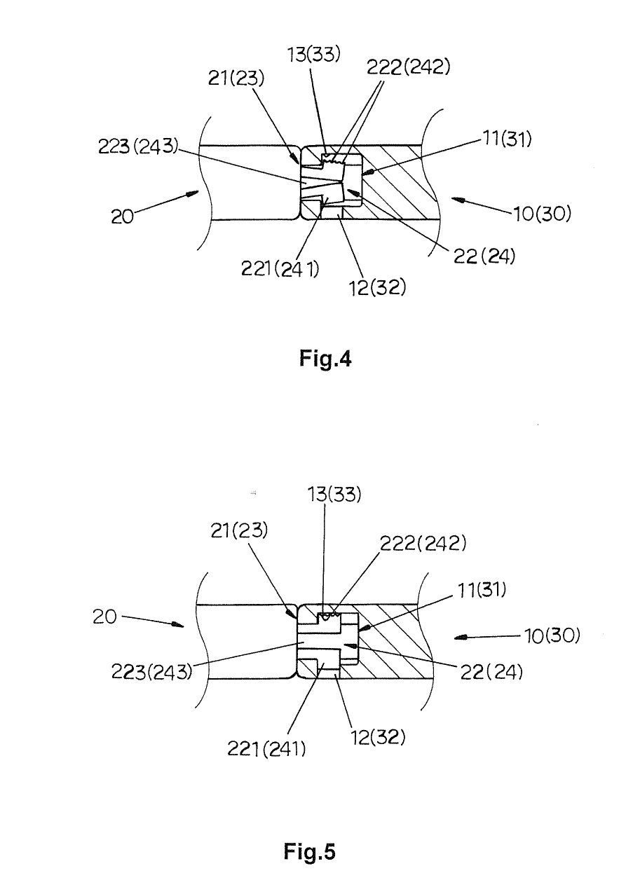

Referring to FIGS. 4 and 5, in assembly, the first protruding member 22 of the respective connecting members 20 is aligned with the first notch 11 of the two temples 10, and the interval 223 makes the first protruding member 22 flexibly deformable, so that the first protruding member 22 can be pressed into the first notch 11 in such a manner that the first pivoting member 221 is pivotally fixed in the first pivot hole 12, and the first engaging tooth 13 is selectively engaged in one of the first engaging grooves 222. Then the second protruding member 24 of the respective connecting members 20 is pressed into the second notch 31 (due to the interval 243 makes the second protruding member 24 flexibly deformable) in such a manner that the second pivoting member 241 is pivotally fixed in the second pivot hole 32, and the second engaging tooth 33 is selectively engaged in one of the second engaging grooves 242.

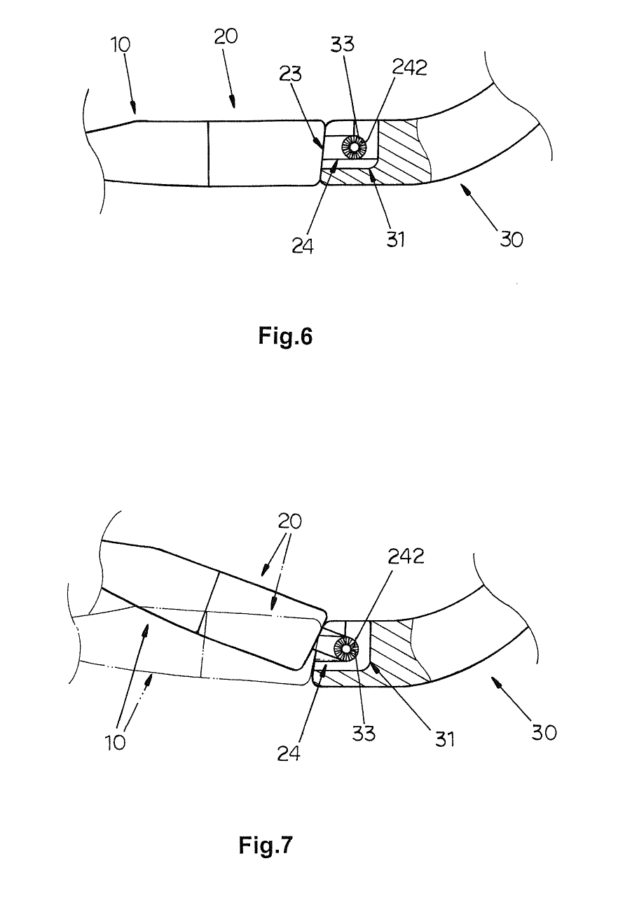

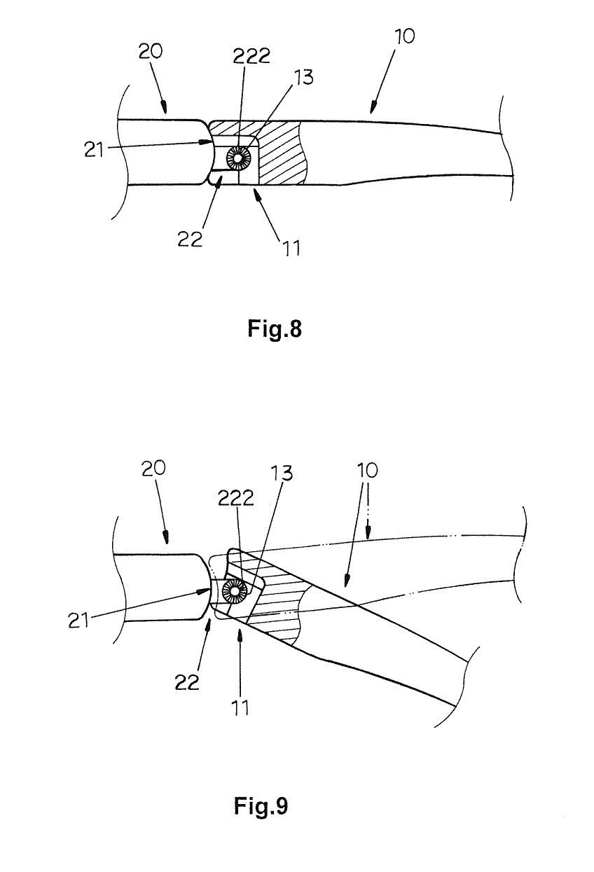

Referring then to FIGS. 6-9, when in use, the two connecting members 20 can be turned to rotate the temples 10, making the second engaging tooth 33 engaged in one of the second engaging grooves 242, so that the connecting members 20 and the temples 10 can be rotated left or right to a desired wearing angle. Then, the two temples 10 can be rotated up and down to make the first engaging tooth 13 engage in one of the first engaging grooves 222. By such arrangements, the two temples 10 can be adjusted in left, right, up and down directions to better fit different faces.

To summarize, the present invention has the following advantages:

Firstly, the body 30 and the two temples 10 are pivotally connected by two connecting members 20 without using any screws, which reduces manufacturing cost while making assembly easier.

Secondly, with the second engaging tooth 33 selectively engaged in one of the second engaging grooves 242, the temples 10 can be adjusted in left and right directions. With the first engaging tooth 13 selectively engaged in one of the first engaging grooves 222, the temples 10 can be adjusted in up and down directions. By such arrangements, the two temples 10 can be adjusted in left, right, up and down directions to better fit different faces.

While we have shown and described various embodiments in accordance with the present invention, it is clear to those skilled in the art that further embodiments may be made without departing from the scope of the present invention.

What is claimed is:

1. A glasses frame comprising:
two temples each including a first notch, a first pivot hole in communication with the first notch, a first engaging tooth formed on an inner surface of the first notch;
two connecting members each including a first protruding member at a first end thereof and to be inserted in the first notch, the first protruding member being provided with a first pivoting member to be pivotally inserted in the first pivot hole and a plurality of annularly arranged first engaging grooves for engaging with the first engaging tooth; and
a body with two ends pivotally connected to a second end of the each of the connecting members, respectively.

2. The glasses frame as claimed in claim 1, wherein each of the connecting members includes a second protruding member at the second end thereof, and the second protruding member is provided with a second pivoting member and a plurality of annularly arranged second engaging grooves, the body is provided at each of two ends thereof with a second notch, a second pivot hole in communication with the second notch for pivotally connecting the second pivoting member, and a second engaging tooth formed on an inner surface of the second notch to selectively engage with one of the second engaging grooves.

3. The glasses frame as claimed in claim 1, wherein the first protruding member is provided with an interval between the first pivoting member and the first engaging grooves.

4. The glasses frame as claimed in claim 2, wherein the second protruding member is provided with an interval between the second pivoting member and the second engaging grooves.
